(19) United States
(12) Patent Application Publication
(10) Pub. No.: US 2024/0377522 A1
(43) Pub. Date: Nov. 14, 2024

(54) POLARIZED RADIO FREQUENCY (RF) DISTANCE AND POSITION MEASUREMENT SENSORY SYSTEM AND TIMING FOR GUIDANCE SYSTEM

(71) Applicant: Omnitek Partners LLC, Ronkonkoma, NY (US)

(72) Inventor: Jahangir S Rastegar, Stony Brook, NY (US)

(73) Assignee: Omnitek Partners LLC, Ronkonkoma, NY (US)

(21) Appl. No.: 18/227,341

(22) Filed: Jul. 28, 2023

Related U.S. Application Data
(60) Provisional application No. 63/394,212, filed on Aug. 1, 2022.

(51) Int. Cl. G01S 13/42; G01S 7/02; G01S 13/48; G01S 13/524

(52) U.S. Cl. CPC G01S 13/426; G01S 7/024; G01S 13/48; G01S 13/5242

(57) ABSTRACT

A roll angle determination method for an object in flight, the method comprising generating and transmitting signal patterns and analyzing a detected signal at a sensor provided on the object and determining a roll angle and zero time of a fundamental frequency of the transmitted signal on a transmitter clock at a sensor processor clock time, and the sensor receiver synchronizing its time with the polarized RF scanning reference source time.

### CROSS-REFERENCE TO RELATED APPLICATION

This application claims the benefit of U.S. Provisional Application No. 63/394,212 filed on Aug. 1, 2022, the entire contents of which is incorporated herein by reference.

This application is related to U.S. Pat. Nos. 6,724,341; 7,193,556; 8,637,798; 8,514,383; 8,446,577; 8,259,292; 8,164,745; 8,093,539; and 8,076,621, the entire contents of each of which are incorporated herein by reference.

### BACKGROUND

### 1. Field

The present disclosure relates generally to distance/position measuring sensors and, more particularly, to systems and methods for the sensors for measuring distance and thereby position of an object/platform using polarized Radio Frequency (RF) signals from scanning polarized RF reference sources.

### 2. Prior Art

The measurement of distance from a moving or stationary platform (object) to another moving or stationary platform (object), particularly when distances are long and one or both platforms are airborne, and when one platform maybe out of line of sight of the other platform, is critical for mapping geo-location, for guiding a platform to its intended positioning, for collision detection, collision avoidance, environmental awareness, and many other intended usages.

The measurement of relative distance between two or more platforms (objects) is useful for guidance and/or steering purposes of all manned and unmanned mobile platforms, such as land vehicles, powered or non-powered airborne platforms, surface or submerged marine platforms, or various space vehicles. In many such systems, onboard information is required as to their absolute (relative to earth) position or their position relative to another platform, such as a reference platform or a destination (target) positioning or platform (object).

It is appreciated that by measuring the distance of an object to three or more reference locations, the object position in the established reference system by those reference locations. In the present disclosure, hereinafter the term position refers to the distance from the distance measuring reference system location to the object/platform, the distance of which is being measured.

This distance derived position information is particularly important for unmanned and guided platforms such as mobile robots, Unmanned Aerial Vehicles (UAV), unmanned guided surface or submerged platforms, and the like. This is also the case in future smart and guided projectiles, including gun-fired munitions, mortars and missiles. Such platforms will also require the aforementioned absolute and/or relative position information onboard the platform for closing the feedback guidance and control loop to guide the platform to the desired static or dynamic target or track a specified fixed or dynamic trajectory or the like.

In certain cases, the onboard position information (absolute or relative to the target, a reference station, another mobile platform, etc.) can be provided by an outside source, for example, by GPS for position or by a radar reading or optical signal that is reflected off some target or received by the mobile platform. In other cases, it is either required or is highly desirable to have autonomous sensors on board the mobile platform, including gun-fired projectiles, mortars and missiles, to directly measure its position with respect to a fixed platform (for example a ground station) or a moving platform.

Currently available sensors for remote measurement of the position of a platform (object) relative to the earth or another object (target or weapon platform) can be divided into the following five major classes.

The first class of sensors measure changes in the position of a platform using inertial devices such as accelerometers. Inertial based sensors, however, generally suffer from drift and noise error accumulation problems. In such sensors, the drift and the measurement errors are accumulated over time since the acceleration must be integrated twice to determine the distance travelled. Thus, the error in the position measurement increases over time. In addition, the initial velocity of the object must be known accurately, which in munitions is difficult to determine due to the initial firing acceleration event. Another shortcoming of inertia-based position sensors is that the position of one object relative to another cannot be measured directly, i.e., the position of each object relative to the inertia frame must be measured separately and used to determine their relative position. As a result, errors in both measurements are included in the relative position measurement, thereby increasing it even further. In addition, electrical energy must be spent during the entire time to continuously make acceleration measurement.

In the case of gun-fired munitions, two other major problems are encountered with inertia-based sensors. Firstly, they must be made to withstand firing accelerations that in certain cases could be in excess of 100,000 Gs. However, to achieve the required guidance and control accuracy over relatively long distances and related times, the accelerometer accuracy must be extremely high. Accelerometer also suffer from settling time problem after being subjected to the initial high G shock loading, which further reduces their overall sensory precision. As a result, the development of high precision inertia-based accelerometers that could withstand the aforementioned high G levels and require near zero settling time is an extremely difficult task.

In addition to the inertia-based position measurement sensors, GPS signals is also used to provide the object position information. Such systems, however, have several significant shortcomings, particularly for munitions applications. These include the fact that GPS signals may not be available along the full path of the flight and that the measurements cannot be made fast enough to make them suitable for guidance and control purposes in munitions, such as gun-fired munitions, mortars and rockets. In addition, GPS signals are generally weak and prone to jamming and spoofing.

The second class of distance measurement systems are based on the use of radio frequency (RF) antennas printed or placed on the surface of an object to reflect RF energy emanating from a ground-based radar system. The reflected energy is then used to track the object on the way to its destination. With such systems, measurement of distance of an object relative to the fixed or moving radar requires enough power to allow detection of the reflected signal, which makes the signal detectable by an adversary and susceptible to jamming and spoofing. In addition, the information about the object distance/position is determined at the radar station and must be transmitted back to the moving object(s) if it is to be used for guidance and/or course correction. It is also very difficult and costly to develop systems that could track multiple projectiles. It is noted that numerous variations of the above method and devices have been devised with all suffering from similar shortcomings.

Another sensory system has also been developed for angular orientation measurement onboard objects based on utilizing polarized Radio Frequency (RF) reference sources and mechanical cavities as described in U.S. Pat. Nos. 6,724,341 and 7,193,556, the entire contents of each is incorporated herein by reference, and hereinafter are referred to as “polarized RF angular orientation sensors”. These angular orientation sensors use highly directional mechanical cavities that are very sensitive to the orientation of the sensor relative to the reference source due to the cross-polarization and due to the geometry of the cavity. The reference source may be fixed on the ground or may be another mobile platform (object). Being based on RF carrier signals, the sensors provide a longer range of operation. The sensors can also work in and out of line of sight. In addition, the sensors make angular orientation measurements directly and would therefore not accumulate measurement error. The sensor cavities receive the electromagnetic energy emitted by one or more polarized RF sources. The angular position of the cavity sensor relative to the reference source is indicated by the energy level that it receives. A system equipped with multiple such waveguides can then be used to form a full spatial orientation sensor. In addition, by providing more than one reference source, full spatial position of the munitions can also be measured onboard the munitions.

The polarized RF based angular orientation sensors provide highly precise angular orientation measurements. The sensors, when embedded in a mobile platform such as in a projectile, can measure full angular orientation of the projectile (mobile platform) relative to the fixed ground station or another moving object such as a UAV or another projectile (mobile platform) where the reference source is located. These angular orientation sensors are autonomous, i.e., they do not acquire sensory information through communication with a ground, airborne or the like source. The sensors are relatively small and can be readily embedded into the structure of most mobile platforms including munitions without affecting their structural integrity. Thus, such sensors are inherently shock, vibration and high G acceleration hardened. A considerable volume is thereby saved for use for other gear and added payload. In addition, the sensors become capable of withstanding environmental conditions such as moisture, water, heat and the like, even the harsh environment experienced by munitions during firing. In addition, the sensors require a minimal amount of onboard power to operate since they do not have to be continuously operating and may be used only when the sensory information is needed.

Briefly, referring now to FIGS. 1 and 2, there is shown a representation of a cavity sensor 100 and its operation with respect to a polarized radio frequency (RF) reference (illuminating) source 101. An electromagnetic wave consists of orthogonal electric (E) and magnetic (H) fields. The electric field E and the magnetic field H of the illuminating beam are mutually orthogonal to the direction of propagation of the illumination beam. When polarized, the planes of E and H fields are fixed and stay unchanged in the direction of propagation. Thus, the illuminating source establishes a (reference) coordinate system with known and fixed orientation. The cavity sensor 100 reacts in a predictable manner to a polarized illumination beam. When three or more cavity sensors are distributed over the body of an object, and when the object is positioned at a known distance from the illuminating source, the amplitudes of the signals received by the cavity sensor 100 can be used to determine the orientation of the object relative to the reference (illuminating) source 101, i.e., in the aforementioned reference coordinate system of the reference source 101. The requirement for the proper distribution of the cavity sensors 100 over the body of the object is that at least three of the cavity sensors be neither parallel nor co-planar.

It is therefore observed that the above RF based angular orientation sensors are dependent on the magnitude of the received signal at the cavity sensors from the reference source to determine the orientation of the sensor relative to the reference source. The use of the signal magnitude, however, has several major shortcomings that limits the utility of such sensors as well as degrades their angular orientation measurement precision. The following are the major shortcomings of the use of signal magnitude information in these cavity sensors for measuring angular orientation relative to the polarized RF reference sources:
1. To relate the magnitude of the received signal to angular orientation, the distance from the reference source to the angular orientation sensors must be known. This in general means that other means must be also provided to measure or indicate the position of the orientation sensors relative to the reference source.
2. In practice, the signal received at the angular orientation sensor is usually noisy, it may face losses due to the environmental conditions, and is also prone to measurement errors at the sensor.
3. The magnitude of the signal received at the angular orientation sensors and its relationship to the angular orientation of the sensors (object to which the sensors are attached) could be significantly different when the object is not in the line-of-sight of the reference source. Therefore, when the object is not in the line-of-sight, the received signal magnitude information cannot yield an accurate angular orientation measurement.

The use of polarized RF reference sources with scanning capability that transmits a specific class of constructed signal pattern would eliminate the above shortcomings of polarized RF cavity angular orientation sensors. The method of constructing a polarized RF scanning reference source and its operation are described in detail in U.S. Pat. Nos. 8,637,798; 8,514,383; 8,446,577; 8,259,292; 8,164,745; 8,093,539; and 8,076,621, the entire contents of each of which are incorporated herein by reference. This would be the case since scanning provides the means of transmitting scanning patterns that are detected by the cavity sensors, from which the sensor angular orientation information can be extracted due to the sensitivity of the received signal to the orientation of the cavity sensor relative to the scanning reference source. In addition, since the cavity sensor is used to detect the pattern of the received signal and not its magnitude and since the signal pattern does not change with distance (only the magnitude of the pattern is reduced by distance), therefore the angular orientation measurement becomes independent of the distance between the reference source and the cavity sensor. Another advantage of using polarized RF scanning reference sources is that in non-line-of-sight conditions, since obstacles do not affect the direction of the plane of polarization and only reduce the signal strength, therefore the signal pattern and the angular orientation information is not affected. Another advantage of using polarized RF scanning reference sources is that since noise and effects of reflections and multi-paths for low wavelength (high frequency) RF transmitted signals is random, their net effect can readily be eliminated by proper signal pattern detecting processing.

The method of constructing a polarized RF scanning reference source and its operation is described in detail the above U.S. patents. In short, referring to FIG. 2, by modulating the amplitudes of the synchronized and polarized fields Eₓ and E_{y}, the referencing source transmits a scanning polarized vector field Ē(t). By properly modulating the two field amplitudes, the desired vector field scanning pattern is obtained. It is noted that Eₓ and E_{y} do not have to be orthogonal.

In general, any desired scanning pattern may be implemented with the present polarized RF scanning reference source. For example, one may choose scanning patterns with peaks that are sharper than a simple harmonic sine wave, thereby increasing the accuracy of a peak detection algorithm. Alternatively, one may add specially designed patterns that will simplify a pattern detection algorithm being used and/or to reject noise, and/or to reduce their susceptibility to detection, jamming and spoofing, or for other application specific purposes. It is noted that the following method may also be used to provide two or even more simultaneous and arbitrarily oriented scanning reference sources. Such multi-range scanning is useful for the establishment of a network of reference sources and/or to limit the range or radiation when multiple sensors (for example, munitions and/or weapon platforms) are using the reference source.

In general, the signal received by cavity sensors from a polarized RF reference source will be sensitive to changes in orientation about any axis (for example the axes indicated by θₓ, θ_{y} and θ_{Z} in FIG. 3). The cavity sensors may, however, be designed with geometries that when positioned in certain direction relative to the referencing source they would be more sensitive to change in one orientation and less sensitive to others. For example the cavity sensor 100 shown in the schematic of FIG. 3 may be designed to be highly sensitive to roll (rotation about the axis Y_{ref}—or the so-called roll, FIG. 1), and less sensitive to rotations about the axes X_{ref} and Z_{ref}, i.e., have high sensitivity to roll and low cross-sensitivity to pitch and yaw.

As previously indicated, the measurement of distance from a moving or stationary platform (object) to another moving or stationary platform (object), particularly when distances are long and one or both platforms are airborne, and when one platform maybe out of line of sight of the other platform, is critical for mapping geo-location, for guiding a platform to its intended positioning, for collision detection, collision avoidance, environmental awareness, and many other intended usages.

Now considering the aforementioned merits of the scanning polarized RF reference sources for making angular orientation measurement onboard a moving object/platform by their cavity sensors relative to a coordinate system established by the scanning polarized RF reference sources, it is highly desirable to develop a method to use the same or similar scanning polarized RF reference sources to measure the distance from each scanning polarized reference source to the moving object/platform and for the object/platform to measure its distance to each scanning polarized RF reference source.

A need, therefore, exists for methods to measure the distance between the previously described scanning polarized RF reference sources and an object/platform, including:
1—A method for the measurement of the distance between a scanning polarize RF reference source and an object/platform and to provide the distance information to the scanning polarize RF reference source platform.
2—A method for the measurement of the distance between a scanning polarize RF reference source and an object/platform and provide the distance information to the scanning polarize RF reference source platform as well as to the object/platform.

The developed methods and sensors and the distance measurement systems are highly desirable to be capable of providing the distance measurement information very rapidly, i.e., do not require highly complex calculations, so that the distance information could be used onboard the object/platform and the scanning polarized RF reference sources to accurately determine the object/platform velocity relative to the scanning polarized RF reference source.

The developed distance measurement methods and sensors may then be used for mapping the position of the objects/platforms in a coordinate system established by the scanning polarized RF reference sources.

It is also highly desirable that the methods and sensors for the measurement of distance between a scanning polarized RF reference source and an object/platform be capable of proving angle information in addition of distance/position information as follows:
1—A method and sensors for the measurement of the distance between a scanning polarize RF reference source and an object/platform and one or more relative angles (orientation) between the two and provide the distance information to the scanning polarize RF reference source platform and angle information to the object/platform.
2—A method and sensors for the measurement of the distance between a scanning polarize RF reference source and an object/platform and one or more relative angles (orientation) between the two and provide the distance and angle information to the scanning polarize RF reference source platform as well as to the object/platform.

It is also highly desirable to develop methods that would provide a moving object/platform with onboard apparatus to determine if the GPS signal is being spoofed and to take appropriate corrective actions.

In addition, several methods and related systems have been developed for providing the sensory information for remotely guiding an object to a desired stationary or moving object or location. Such methods and related systems include those that use lasers that are pointed in the desired direction or at a desired stationary or moving target object or location. Such methods and related system have a number of shortcomings, including limited range; that they work only in line-of-sight; and that they do not provide sensory information related to orientation about the direction of travel, such as roll angle of a remotely guided flying object, for example, an Unmanned Aerial Vehicle (UAV) or a rocket.

Other methods for determining distance uses lasers. In these methods, distance measurement is done by transmitting pulses of laser light at the target and timing the return of the light back to a light detector on the transmitter. A high-speed processor then calculates the distance between the laser transmitter and the object it was pointing at based upon the measured return time. The main shortcoming of this method is that the object has to be in line of sight and it should also be large enough to provide a strong enough reflected lase light return for the detector of the transmitter to be able to detect it.

Other methods for measuring distance uses Radar, in which similar two the aforementioned laser-based methods, a transmitted pulse is reflected against the target object, and the distance is measured at the transmitted from the time of pulse travel. These methods are not suitable for relatively small objects, since they do not provide strong enough return signal for detection. The object must also be metallic to reflect the Radar signal. One main shortcoming of these methods for use in munitions is that the transmitted signal, particularly for use with relatively small and distant objects such munitions, particularly gun-fire munitions, would be easily detected by the adversary.

Other methods also include the use of GPS, which may not be available at the location and/or may not be accurate enough for a given application and/or may have been jammed or spoofed. GPS based methods are also relatively slow and are not suitable for guidance of munitions against fast moving targets. In addition, the position information needs to be communicated to the base (fire control) station, and the base station needs to determine its position using the GPS signal, thereby adding two GPS location measurement errors to the munition guidance system.

### SUMMARY

A need, therefore, exists for methods and sensors to simultaneously measure the distance between a previously described scanning polarized RF reference sources and an object/platform and at least one angular orientation of the object/platform relative to the scanning polarized RF reference source. The methods and sensors may provide the distance and angle measurements to one or both the scanning polarized RF reference source platform and the object/platform.

Accordingly, methods and related sensory systems are provided that can be used to simultaneously measure the distance between a scanning polarized RF reference sources and an object/platform and at least one angular orientation of the object/platform relative to the scanning polarized RF reference source. The methods and sensors may provide the distance and angle measurements to one or both the scanning polarized RF reference source platform and the object/platform.

A need also exists for methods that can be used for the previously described scanning polarized RF reference sources to determine the position of an object/platform with respect to their own position, for example, in a reference coordinate system established by the scanning polarized RF reference sources, and for the object/platform to determine its position relative to the scanning polarized RF reference sources, for example, in the reference coordinate system established by the scanning polarized RF reference sources. The position may refer to a “planar positioning”, e.g., positioning over a nearly plane surface, such as a nearly flat surface of the earth for geo-locating/mapping. Alternatively, position may refer to the full positioning of the object/platform in the three-dimensional reference coordinate system defined with respect to the scanning polarized RF reference sources.

A need also exists for methods that would enable an object/platform, such as a munition, to sense, geolocate, and relay target and munition data from multiple sources to a central station/platform, such as to fire control and battle management systems in the case of a munition.

Accordingly, methods are provided that can be used for the scanning polarized RF reference sources to determine the position of an object/platform with respect to their own position, for example, in a reference coordinate system established by the scanning polarized RF reference sources, and for the object/platform to determine its position relative to the scanning polarized RF reference sources, for example, in the reference coordinate system established by the scanning polarized RF reference sources. The position may refer to a “planar positioning”, e.g., positioning over a nearly plane surface, such as a nearly flat surface of the earth for geo-locating/mapping. Alternatively, position may refer to the full positioning of the object/platform in the three-dimensional reference coordinate system defined with respect to the scanning polarized RF reference sources.

A need therefore exists for methods and apparatus for a moving object/platform to determine its actual position at least occasionally as should have been determined by the GPS signal and thereby determine if the GPS signal is being spoofed and then to take an appropriate corrective action.

Accordingly, methods and apparatus for a moving object/platform to determine its actual position at least occasionally as should have been determined by the GPS signal and thereby determine if the GPS signal is being spoofed and then to take an appropriate corrective action.

A need also exists for methods to synthesize efficient polarized RF reference source scanning patterns that can provide the information required for distance measurement calculations between the scanning polarized RF reference sources and an object/platform.

Accordingly, methods for synthesizing polarized RF scanning patterns that can be efficiently used for distance measurement calculations between the scanning polarized RF reference sources and objects/platforms are provided.

It is appreciated by those skilled in the art that since all the aforementioned distance measurements are relative distance measurements, i.e., distances between an object/platform and one or more scanning polarized RF reference sources, therefore the object/platform and/or one or more of the scanning polarized RF reference sources may be stationary or moving relative to the earth.

It is also appreciated by those skilled in the art that one or more of the objects/platforms or the scanning polarized RF reference source platforms may be provided with an apparatus of obtaining the location of a target, for example, an UAV that also serves as one of the scanning polarized reference sources may be provided to determine the location of a target, and then the UAV (i.e., the UAV scanning polarized reference source platform) may then provide the position of the target to other scanning polarized reference sources and/or other objects/platforms. It is appreciated by those skilled in the art that a methods and systems to function as “homing” sensors for guiding flying objects remotely to a desired location or to intercept a moving target, where the desired location or to moving target to be intercepted is designated from a fixed or mobile station can also be used for guiding mobile objects, such as Unmanned Ground Vehicles (UGV) or the like on the ground or unmanned moving objects on water or serve as a “homing” sensor to direct the driver of a manned ground vehicles or the like towards the said desired location or to intercept a moving target.

Hereinafter, the methods and sensory devices and systems will be described for a flying object with no intention of excluding their application to fixed or mobile objects on the ground such as UGVs and other mobile platforms or even people or animals.

A need therefore also exists for methods and systems to function as “homing” sensors for guiding flying objects remotely to a desired location or to intercept a moving target, where the desired location or to moving target to be intercepted is designated from a fixed or mobile station.

A need also exists for methods and systems to function as “homing” sensors for guiding flying objects remotely to a desired location or to intercept a moving target, where the methods and systems can provide at least one angular orientation information onboard the flying object.

In many applications, there is also a need that the said methods and systems to function as “homing” sensors for guiding flying objects remotely to a desired location or to intercept a moving target be relatively low power and occupy relatively small volumes. This is particularly desirable in munitions, UAVs and the like applications.

Another objective is to provide methods and systems that would function as “homing” sensors for guiding flying objects remotely to a desired location or to intercept a moving target, where the desired location or to moving target to be intercepted is designated from a fixed or mobile station.

### BRIEF DESCRIPTION OF THE DRAWINGS

These and other features, aspects, and advantages of the apparatus will become better understood with regard to the following description, appended claims, and accompanying drawings where:

FIG. 1 illustrates a schematic representation of a cavity sensor with respect to a polarized radio frequency (RF) reference source of the prior art.

FIG. 2 illustrates a scanning polarized vector field Ē(t) of a polarized RF scanning reference source that is generated by two synchronized and orthogonally directed modulating polarized RF transmitters that are positioned at the origin of the Cartesian XY coordinate system O.

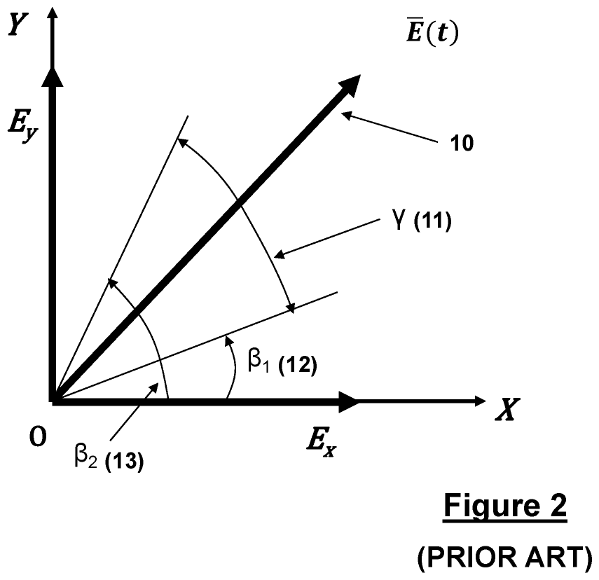

FIG. 3 illustrates a schematic representation of a cavity sensor with respect to a polarized radio frequency (RF) reference source of the prior art.

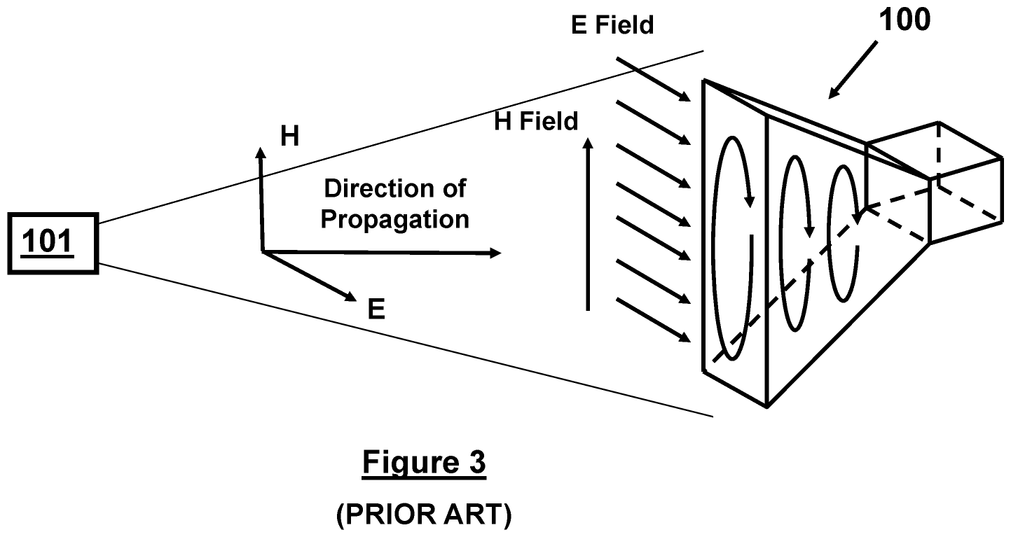

FIG. 4 illustrates the configuration of a polarized RF scanning reference source and a cavity sensor for measuring roll angle.

FIG. 5 illustrates the scanning polarized vector field Ē(t) obtained by modulating the amplitudes of the synchronized and polarized fields Eₓ and E_{y} and the indicated roll angle as shown in the configuration of FIG. 4.

FIG. 6 is the plot of an example of the transmitted polarized fields Eₓ and E_{y} for the pattern for roll angle measurement (top plot) and its harmonic component (bottom plot).

FIG. 7 is the plot of the detected signal pattern (top) at the object receiver sensor for the transmitted polarized fields Eₓ and E_{y} of FIG. 6 and its ω, 2ω and 3ω harmonic amplitudes (bottom).

FIG. 8 illustrates the block diagram of the polarized RF scanning pattern based sensory system of FIG. 4 for the object measuring its roll relative to a scanning polarized RF transmitter source.

FIG. 9 illustrates the modified block diagram of the polarized RF scanning pattern based sensory system of FIG. 8 for the object measuring its roll angle relative to the scanning polarized RF transmitter source and for the scanning polarized RF transmitter source to measure its distance to the object and for the object to measure its distance from the scanning polarized RF transmitter source.

### DETAILED DESCRIPTION

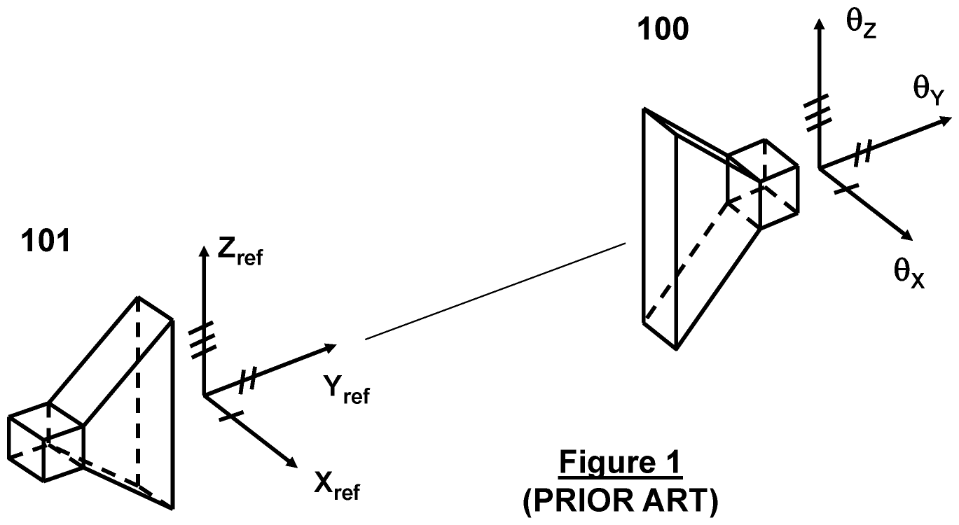

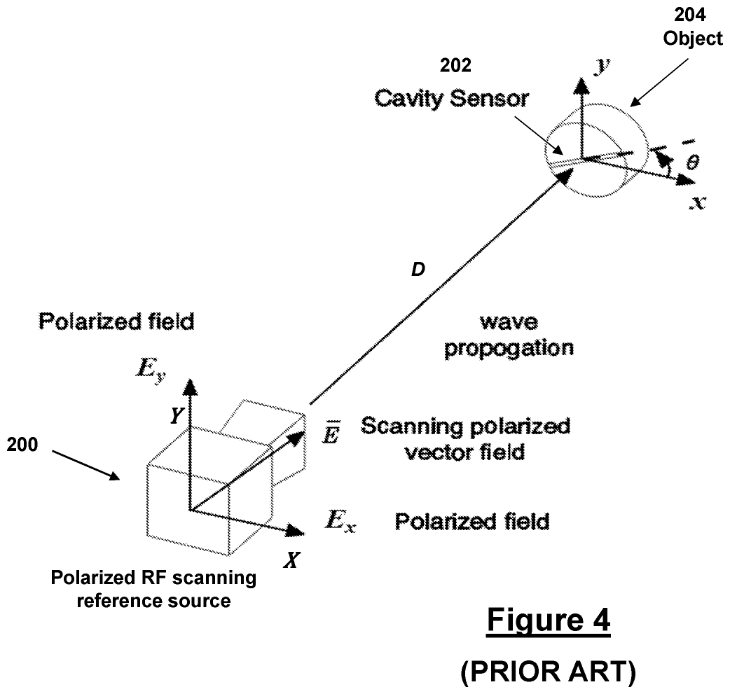

The polarized RF angular sensory systems are best described as being configured for measuring the roll angle of an object on which the sensor cavity is provided, as shown in the schematic of FIG. 4. FIG. 4 shows a polarized RF scanning reference source 200 to which the XYZ Cartesian coordinate system is fixed. In the coordinate system XYZ, the Z axis is along the direction of the propagating electromagnetic wave D (in the −Z direction using the right-hand rule). A cavity sensor 202 is fixed to an object 204 and is positioned a distance d in far field of the polarized RF scanning reference source. The roll angle θ of the cavity sensor 202 (i.e., of the object 204) is measured from the sensor cavity orientation shown in FIG. 4, such that at the roll angle θ=0 and with polarized fields Eₓ being transmitted while the polarized field E_{y} is off, the cavity sensor output is maximum. This roll angle referencing configuration is arbitrary and may be varied but is selected since it simplifies the roll angle measurement calculations described below. In addition, for a symmetrically designed sensor cavity 202 like the horn shaped cavity sensor 100 of FIG. 1, the roll angle θ=0 configuration corresponds to the orientation in which cross-polarization angle of the transmitted polarized field Eₓ with the receiving cavity sensor terminal is also zero.

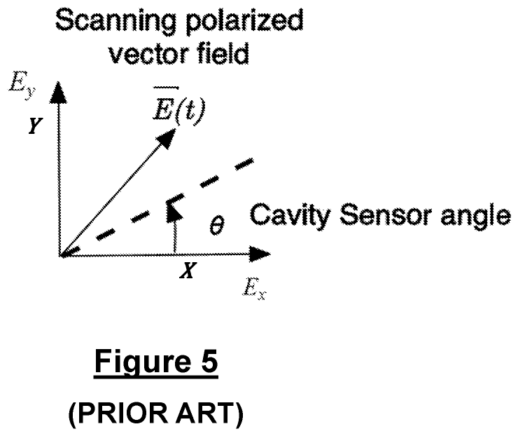

Referring to FIG. 5, by modulating the amplitudes of the synchronized and polarized fields Eₓ and Ey, the referencing source transmits a scanning polarized vector field Ē(t). By properly modulating the two field amplitudes, the desired vector field scanning pattern is obtained. It is noted that Eₓ and E_{y} do not have to be orthogonal. In the present configuration of FIG. 4, the (roll) angle to be measured by the sensor is the angle θ as shown in FIGS. 4 and 5.

FIG. 5 shows the scanning polarized vector field Ē(t) obtained by modulation of the amplitudes of the synchronized and polarized fields Eₓ and E_{y} (traveling in the XZ and YZ planes, respectively) of the polarized RF scanning reference source and the aforementioned roll angle θ. As was previously described, by properly modulating the amplitudes of the two fields Eₓ and E_{y}, the desired vector field scanning pattern is obtained. It is noted that Eₓ and E_{y} do not have to be orthogonal.

The field strength detected by the cavity sensor 202 at an angle θ is given by the scalar function R(t) as

$$R ( t ) = g ( D ) f ( \overline{E} ( t ) , θ ) \qquad ( 1 )$$

where g(D) is the gain related to the distance D between the scanning reference source and the cavity sensor and the existing environmental factors. Since the time taken to make an angle measurement is very small, changes in the gain g(D) during each angle measurement are negligible and the gain g(D) can be considered to stay constant.

The mapping function ƒ(Ē, θ) is determined by the design of the cavity sensor and its calibration. The geometry of the cavity is designed, and the pick-up terminal is located to maximize sensitivity to roll angle and minimize sensitivity to pitch and yaw. Since the angle θ is measured by matching the scanning pattern, the effect of the fixed gain g(D) is eliminated during each angle measurement as described in the following example pattern.

For a properly formulated scanning pattern for the polarized RF reference source, the roll angle θ is readily extracted from the received signal at the cavity sensor from the measured amplitude pattern of the vector R(t), the known mapping function ƒ(Ē, θ), and the scanning pattern of the vector Ē(t) as shown in the following example.

As an example, consider a scanning vector field Ē(t)=Eₓ(t)\hat{ι}+E_{y}(t)Ĵ formed by the orthogonal synchronized polarized electric field signals Eₓ(t) and E_{y}(t) shown in FIGS. 4 and 5, and which are modulated as follows

$${E}_{x} ( t ) = a ( cos ω t + cos 2 ω t ) + b \qquad ( 2 )$$

$${E}_{y} ( t ) = a ( sin ω t + sin 3 ω t ) + b \qquad ( 3 )$$

where ω is the fundamental frequency of both signals, a is a constant signal amplitude and b is the constant that provides a proper amplitude modulation index.

The electric field detected by the cavity sensor 202 will then become

$$\begin{matrix}R ( t ) = g ( D ) ( {E}_{x} ( t ) cos θ + {E}_{y} ( t ) sin θ ) \\ = g ( D ) \{ [ a ( cos ω t + cos 2 ω t ) + b ] cos θ + \\ [ a ( sin ω t + sin 3 ω t ) + b ] sin θ \} \\ = g ( D ) [ a ( cos ω t cos θ + sin ω t sin θ ) + a cos θ cos 2 ω t + \\ a sin θ sin 3 ω t + b ( sin θ + cos θ ) ] \\ = g ( D ) [ a cos ( ω t - θ ) + a cos θ cos 2 ω t + \\ a sin θ sin 3 ω t + b ( sin θ + cos θ ) ]\end{matrix} \qquad ( 4 )$$

It is readily seen from (4) that the roll angle θ can be determined from the phase shifting of the fundamental frequency ω and the zero crossing of the fundamental frequency that occurs when the harmonics 2ω and 3ω are in phase as shown in the example below. This can be done since as can be seen in equation (4), when ωt=π/2, cos 2ωt=−1 and sin 3ωt=−1, i.e., the harmonics 2ω and 3ω are in phase. The time corresponding to ωt=π/2 would obviously correspond to quarter of the period T of the fundamental frequency ω, i.e., T/4.

As expected, the gain g(D) does not affect the angle measurement, therefore angle measurement has become independent of position (distance) measurement. The angle θ can then be determined from the received signal, equation (4), as shown in the following example.

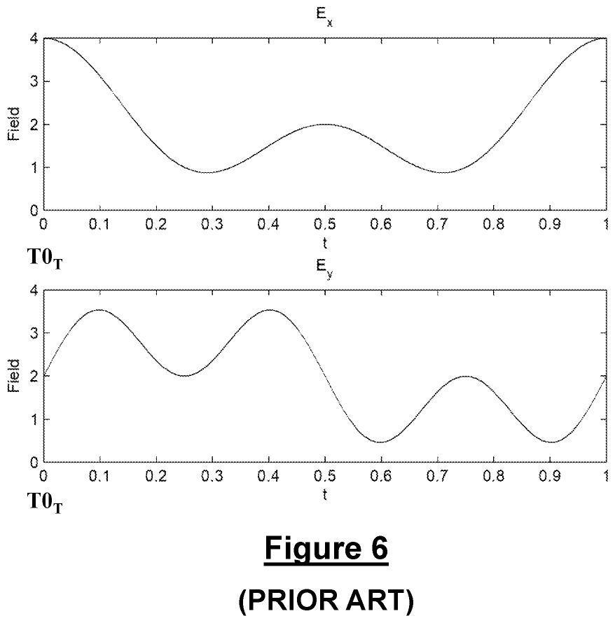

As an example, in the orthogonal synchronized polarized electric field signals Eₓ(t) and E_{y}(t) of equations (2) and (3), let a=1 and b=2. The resulting polarized electric field patterns Eₓ(t) and Eₓ(t) are shown in FIG. 6 for a period of the fundamental frequency T (normalized to a unit 1).

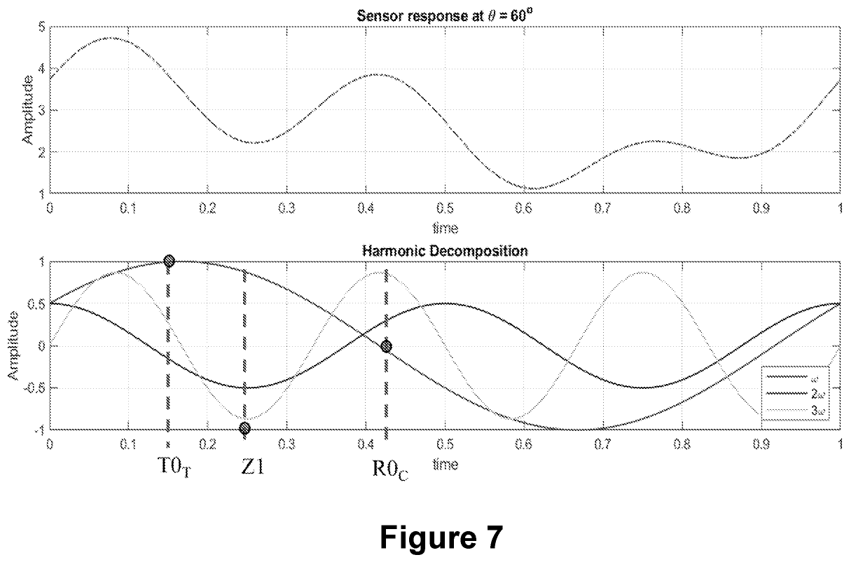

The detected amplitude pattern of the detected signal R(t), equation (4), at the sensor receiver 202, FIG. 4, when the angle θ=60° is shown in the top plot of FIG. 7. The amplitudes of the detected fundamental frequency w and its first two harmonics 2ω and 3ω obtained by Fourier integration of the detected signal is also shown in the bottom plot of FIG. 7.

In FIG. 7, the time of zero-crossing of the fundamental frequency harmonic is indicated as the point R0c and the zero time in equations (2)-(4), is also indicated as the point T0_{T}. Fourier integration of the received signal over the period T of the fundamental frequency ω shown in the top plot of FIG. 7 provides the harmonic content of the received signal as shown in the bottom plot of FIG. 7. The harmonics 2ω and 3ω are in phase at the point Z1 corresponding to ωt=π/2, i.e., at the normalize scale of 0.25 in FIG. 7, i.e., a quarter of the period T of the fundamental frequency ω of the received signal. The zero-crossing point R0_{C} of the fundamental frequency, which can be measured to be at 0.417 in the normalized scale of FIG. 7, is at cos(ωt−θ)=0, i.e., when (ωt−θ)=π/2. The angle θ, i.e., the phase of the fundamental frequency of the received signal, FIG. 7, which corresponds to the difference between the zero-crossing of the fundamental frequency R0_{C} and the point Z1, can then be calculated to be 0.167, which corresponds to angle θ=60 degrees. The zero-time T0_{T} at the transmitter 200, FIG. 4, of the transmitted signal, equations (2) and (3), being located a quarter of the period T of the fundamental frequency ω before the zero-crossing point R0_{C} of the fundamental frequency ω is then determined in the clock time of the receiver 202.

One very important feature of the patterns of the type presented in this example is that they provide a reference position angle, which is fixed in the referencing coordinate system of the scanning referencing source at the T0_{T}, FIG. 7.

The polarized RF scanning pattern of equations (2) and (3) is shown to have the unique characteristic of yielding the roll angle and time reference through readily detectable fundamental frequency and its first two harmonics. The detection electronics is also made simple and low cost and since the pattern is known to the detection signal processing unit, the roll angle can be recovered even when the signal-to-noise ratio of the measured RF signal is very low and even below unity. In fact, a signal pattern may even be hidden in the environmental noise, making the system immune to all countermeasures. The polarized nature of the scanning pattern along with being transmitted in short and random pulses, makes it almost impossible to jam or spoof.

In addition, the ratio of the amplitudes of the second and first harmonics, i.e., the ratio of the amplitudes of the harmonics with frequencies 3ω and 2ω, respectively, is seen to be tan(θ), which provides a second measurement for the roll angle. As a result, the angle measurement can be made more accurately, and the sensory system becomes more robust. In addition, by using more appropriate harmonics of the fundamental frequency in the transmitted polarized signals Eₓ and E_{y}, the angle measurement can be made from multiple phase shifts and multiple ratios of the amplitudes of the higher harmonics of the fundamental frequency, thereby significantly increasing the angle measurement accuracy and the robustness of the sensory system.

It is appreciated that the features of the transmitted pattern by the orthogonal synchronized polarized electric field signals Eₓ(t) and E_{y}(t), shown in FIGS. 4-6, an example of which is the modulated transmitted polarized RF signals described by equations (2) and (3), may also be provided with other specifically designed transmitted patterns. For example, the pattern described by the equations (2) and (3) may be used with added higher harmonics of the fundamental frequency ω, but by adding odd harmonics to the Eₓ(t) component and even harmonics to the E_{y}(t) component of the polarized electric field signal, such as the third harmonic to the Eₓ(t) component the fourth harmonic to the E_{y}(t) to get

$${E}_{x} ( t ) = a ( cos ω t + cos 2 ω t + cos 4 ω t ) + b \qquad ( 5 )$$

$${E}_{y} ( t ) = a ( sin ω t + sin 3 ω t + sin 5 ω t ) + b \qquad ( 6 )$$

where ω is the fundamental frequency of both signals, a is a constant signal amplitude and b is the constant that provides a proper amplitude modulation index.

The electric field detected by the cavity sensor 202 will then become

$$\begin{matrix}R ( t ) = g ( D ) ( {E}_{x} ( t ) cos θ + {E}_{y} ( t ) sin θ ) \\ = g ( D ) \{ [ a ( cos ω t + cos 2 ω t + cos 4 ω t ) + b ] cos θ + \\ [ a ( sin ω t + sin 3 ω t + sin 5 ω t ) + b ] sin θ \} \\ = g ( D ) [ a ( cos ω t cos θ + sin ω t sin θ ) + a cos θ cos 2 ω t + \\ a sin θ sin 3 ω t + a cos θ cos 4 ω t + a sin θ sin 5 ω t + b ( sin θ + cos θ ) ] \\ = g ( D ) [ a cos ( ω t - θ ) + a cos θcos 2 ω t + \\ a sin θsin3ω t + a cos θ cos 4 ω t + a sin θ sin 5 ω t + b ( sin θ + cos θ ) ]\end{matrix} \qquad ( 7 )$$

The scanning vector field Ē(t)=Eₓ(t)\hat{ι}+E_{y}(t)J̅ formed by the orthogonal synchronized polarized electric field signals Eₓ(t) and E_{y}(t) would then provide a point at which the harmonics with frequencies of 3ω and 2ω are in phase, like point Z1 in FIG. 7, and also a point at which the harmonics with frequencies of 5ω and 4ω are in phase, both at ωt=π/2. Thus, leading two measurements for the angle θ, which make its measurement more accurate. In addition, two amplitude ratios, i.e., the ratio of the amplitudes of the 3ω and 2ω harmonics, and also the ratio of the amplitudes of the of 5ω and 4ω harmonics yield tan(θ), thereby the angle θ, thereby resulting in a more accurate measurement of the angle θ.

It is also appreciated by those skilled in the art that other pairs of cosine and sine functions with frequencies 2nω and (2n+1)ω, respectively, may also be added to the orthogonal synchronized polarized electric field signals Eₓ(t) and E_{y}(t), respectively, to similarly obtain two added measurement for the angle θ, thereby making its measurement even more accurate.

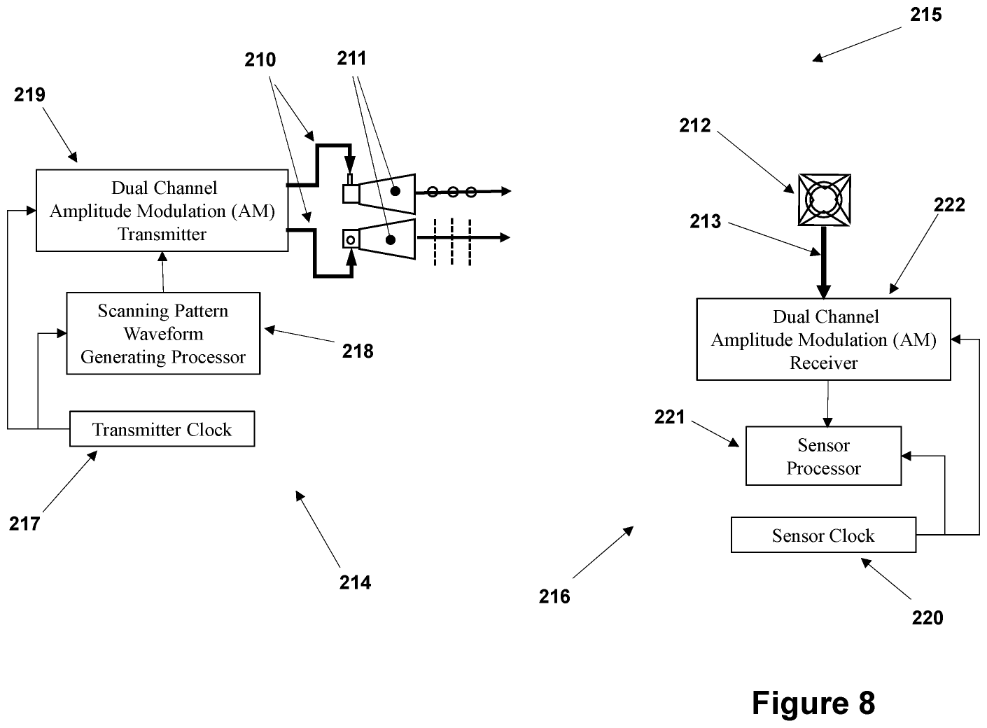

FIG. 8 presents the block diagram of the sensory system embodiment 215, comprising of a transmitter 200, FIG. 4, that transmits the polarized RF scanning pattern, for example the pattern described by the equations (2) and (3), the cavity sensor 202, FIG. 4, and other sensory system components that are required for the sensory system to provide the roll angle θ of the object 204, relative to the polarized RF scanning reference source 200 as shown in the schematic of FIG. 4.

The sensory system embodiment 215 of FIG. 8 comprises two components, a polarized RF scanning reference source 214 component, and at least one cavity sensor receiver 216 that is attached to the object that its roll angle is desired to be determined onboard the object relative to the polarized RF scanning reference source 214 as was previously described. In general, a cavity sensor is used onboard the object that has high sensitivity to the receiving scanning polarized signal as described previously.

It is appreciated by those skilled in the art that the reason for indicating that more than one cavity sensor receiver 216 may be present is that in general multiple objects may be provided with such cavity sensor receivers 216, and all such objects can simultaneously measure their roll angles relative to the polarized RF scanning reference source 214.

As can be seen in the block diagram of FIG. 8, the polarized RF scanning reference source 214 component of the sensory system 215 comprises a “Transmitter Clock” 217, which is used by the processor 218, which is tasked to generate the two scanning pattern waveform, for example, the waveforms of equations (2) and (3) or (5) and (6), for the orthogonal synchronized polarized electric field signals Eₓ(t) and E_{y}(t), respectively. The two generated signals Eₓ(t) and E_{y}(t) are sent to the pair of antennas 211 via the transmission lines 210, which are oriented to properly transmit the orthogonal synchronized polarized signals.

As can be seen in the block diagram of FIG. 8, the cavity sensor receiver 216 component of the sensory system 215 comprises a “Sensor Clock” 220, which is used by the sensor processor 218, which is tasked to perform the aforementioned Fourier transform operation on the detected signal, for example those described by equation (4) or (7), such as those shown in the plots of FIG. 8. The transmitted signal by the polarized RF scanning reference source 214 component of the sensory system 215 is detected by the cavity sensor (antenna) 212 of the cavity sensor receiver 216 component of the sensory system 215 and is sent to the dual channel Amplitude Modulation (AM) receiver 222 via the transmission line 213.

It is appreciated that the “Transmitter Clock” 217 of the polarized RF scanning reference source 214 component of the sensory system 215 and the “Sensor Clock” 220 of the cavity sensor receiver 216 component of the sensory system 215 are real time clocks and continuously keep track of the elapsed time and have their own time reference, and their time reference is usually different from each other. However, their measurement of an elapsed time period has high precision for the above and the following elapsed time measurement requirements.

The sensory system 215 would then operate as follows. At any desired point of time, a scanning pattern, equations (2) and (3) or (5) and (6) or other appropriate patterns as was previously described, is generated for the orthogonal synchronized polarized electric field signals Eₓ(t) and E_{y}(t), respectively, by the “Scanning Pattern Waveform Generating Processor” 218.

It is appreciated that the generated waveform when generated with the waveforms described by equations (2) and (3) would be as plotted in FIG. 6, which illustrates on period (cycle) of the generated pattern.

It is also appreciated by those skilled in the art that in general, more than one cycle (period) of the waveform is generated and transmitted, each cycle of which is hereinafter considered to start from a time=0, which corresponds to the time that is hereinafter referred to as the “Transmitter Clock” 217 “zero time” of the polarized RF scanning reference source 214 component of the sensory system 215, for example, the time T0_{T} in FIG. 7, which is also hereinafter referred to as the “zero time” of the “transmitted signal pattern”. The time reference in the “Transmitter Clock” 217 is also hereinafter referred to as the “transmitter time”.

The generated orthogonal synchronized polarized electric field signals Eₓ(t) and E_{y}(t) are then transmitted to the pair of antennas 211, which are oriented to properly transmit the orthogonal synchronized polarized signals in the planes of XZ and YZ, FIG. 4, via transmission lines 210.

The two synchronized polarized electric field signals Eₓ(t) and E_{y}(t) are then detected by the cavity sensor (antenna) 212 of the cavity sensor receiver 216 component of the sensory system 215, FIG. 8. The detected signal is then transmitted to the “Dual Channel Amplitude Modulation (AM) Receiver” 222 via the transmission line 213, where it is generally amplified and digitized and sent to the “sensor Processor” 221.

The “Sensor Processor” 221 would then use a well-known Fourier integration algorithm to extract the fundamental frequency and its harmonics constituting the detected signal pattern, for example the fundamental frequency and its first two harmonics for the transmitted pattern described by equations (2) and (3), FIG. 7, in the “Sensor Clock” time reference, which hereinafter is referred to as the “sensor time” and if it refers to the object on which the cavity sensor receiver 216 component is mounted, then it is referred to as the “object time”.

The “sensor processor” would then identify the time (in the reference time of the “Sensor Clock”) at which the first and second harmonics of the fundamental frequency ω harmonic, i.e., the harmonics with frequencies 2 and 3 are in phase (Z1 in FIG. 7, at 0.25 T), the time (in the reference time of the “Sensor Clock”) of zero crossing R0_{C}, FIG. 7, of the fundamental frequency harmonic, and thereby the zero time T0_{T}, i.e., the aforementioned zero-time for the transmitted signal pattern in the “Transmitter Clock” 217 reference time, in the reference time of the “Sensor Clock”. It is noted that as it was previously described, the time TOT in the “Sensor Clock” reference time is located 0.25 T (i.e., π/2 of the full cycle of the fundamental frequency harmonic) before the zero-crossing R0_{C} of the fundamental frequency harmonic, as shown in FIG. 7. The angle θ, which is the phase shift of the detected signal, equation (4), is then determined as the corresponding angle between the points R0_{C} and Z1, FIG. 7, on the detected signal.

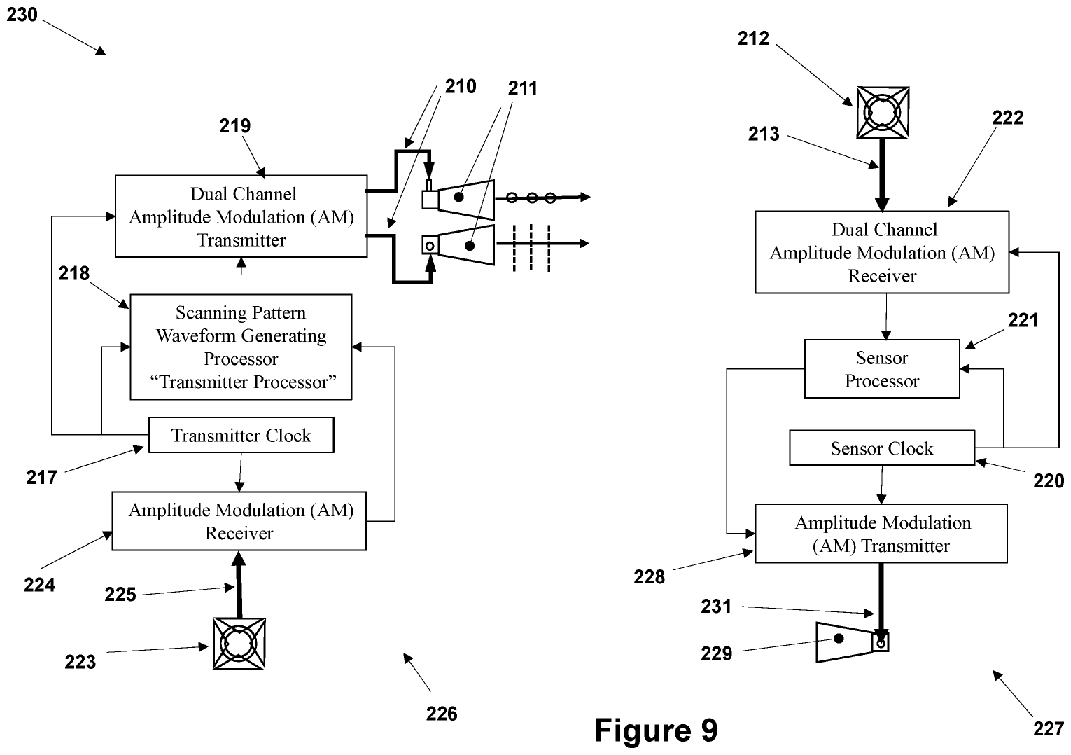

The sensory system 215 of FIG. 8 may be modified as described below to make the polarized RF scanning reference source component to measure its distance from the object on which the cavity sensor component 216 of the system is mounted. The modified sensory system may also be used to enable the cavity sensor component 216 of the sensory system 215 to measure its distance from the polarized RF scanning source component 214 of the system. The modified sensory system is presented in the block diagram of FIG. 9 and is indicated as the sensory system embodiment 230.

The sensory system embodiment 230 of FIG. 9 comprises the same two components, i.e., the polarized RF scanning reference source 214 component, and at least one cavity sensor receiver 216, as shown in FIG. 8, but with the following modifications to each of these two components to make the sensory system 230 capable of providing the aforementioned distance measurement between the two compartments.

It is appreciated by those skilled in the art that the reason for indicating that more than one cavity sensor receiver 216 (and their following modified versions) may be present is that in general multiple objects may be provided with such cavity sensor receivers 216, and all such objects can simultaneously measure their roll angles relative to the polarized RF scanning reference source 214 (and their following modified versions) and relative distances between the polarized RF scanning reference source 214 (and their following modified versions) and each of the modified cavity sensor receiver provided objects.

In the sensory system embodiment 230 of FIG. 9, the polarized RF scanning reference source 226 component is identical to the polarized RF scanning reference source 214 component of the sensory system 215 of FIG. 8, but with the added sensor (antenna) 223, which could be the same as cavity sensor (antenna) 212, and an “Amplitude Modulation (AM) Receiver” 224, to which the detected signal by the antenna 223 is transmitted by the transmission line 225. The “Amplitude Modulation (AM) Receiver” 224 operates using the “Transmitter Clock” 217 and transmits the received signal by the antenna 223 to the “Transmitter Processor” 218 in the “Transmitter Clock” reference time as it is received.

In the sensory system embodiment 230 of FIG. 9, the at least one cavity sensor receiver component 227 is identical to the cavity sensor receiver 216, FIG. 8, but with an added antenna 229, which could be the same as a transmitter antenna 211, and an “Amplitude Modulation (AM) Transmitter” 228, which receives the signal to be transmitted from the “Sensor Processor” 221 and transmits the signal to the antenna 229 via the transmission line 231. The “Amplitude Modulation (AM) Transmitter” 228 operates using the “Sensor Clock” 220 and transmits the received signal by the antenna 229 in the “Sensor Clock” reference time as it is received from the “Sensor Processor” 221.

The sensory system embodiment 230 can then be used to provide the capability for the system polarized RF scanning reference source component 226 to measure its distance to the object on which the cavity sensor receiver component 227 is mounted as described below. The object to which the cavity sensor receiver component is attached can simultaneously determine its roll angle relative to the polarized RF scanning reference source component 226 as was previously described.

The sensory system embodiment 230 would use the following method to allow the polarized RF scanning reference source component 226 to measure its distance to the object on which the cavity sensor receiver component 227 is mounted.

As the operation of the sensory system embodiment 215 of FIG. 8 was previously described, at any desired point of time in the “Transmitter Clock” time reference, a scanning pattern, equations (2) and (3) or (5) and (6) or other appropriate patterns as was previously described, is generated for the orthogonal synchronized polarized electric field signals Eₓ(t) and E_{y}(t), respectively, by the “Scanning Pattern Waveform Generating Processor” 218. The generated waveform when generated with the waveforms described by equations (2) and (3) would be as plotted in FIG. 6, which illustrates one period (cycle) of the generated pattern.

It is also appreciated that as it was previously indicated, each transmitted waveform (pattern) cycle is considered to start from a time=0, which corresponds to the time that was referred to as the “Transmitter Clock” 217 “zero time” of the polarized RF scanning reference source 226 component of the sensory system 230, for example, the time T0_{T} in FIGS. 6 and 7, which was also referred to as the “zero time” of the “transmitted signal pattern”. The time reference in the “Transmitter Clock” 217 was also referred to as the “transmitter time”.

The generated orthogonal synchronized polarized electric field signals Eₓ(t) and E_{y}(t) are then similarly transmitted to the pair of antennas 211, which are oriented to properly transmit the orthogonal synchronized polarized signals in the planes of XZ and YZ, FIG. 4, via transmission lines 210.

The two synchronized polarized electric field signals Eₓ(t) and E_{y}(t) are then detected by the cavity sensor (antenna) 212 of the cavity sensor receiver 227 component of the sensory system 230, FIG. 9. The detected signal is then transmitted to the “Dual Channel Amplitude Modulation (AM) Receiver” 222 via the transmission line 213, where it is generally amplified and digitized and sent to the “sensor Processor” 221.

The “sensor Processor” 221 would then similarly use a well-known Fourier integration algorithm to extract the fundamental frequency and its harmonics constituting the detected signal pattern, for example the fundamental frequency and its first two harmonics for the transmitted pattern described by equations (2) and (3), FIG. 7, in the “Sensor Clock” time reference, which was referred to as the “sensor time” and if it refers to the object on which the cavity sensor receiver 227 component is mounted, then it was referred to as the “object time”.

The “sensor processor” would then identify the time (in the reference time of the “Sensor Clock”) at which the first and second harmonics of the fundamental frequency ω harmonic, i.e., the harmonics with frequencies 2ω and 3ω are in phase (Z1 in FIG. 7, at 0.25 T), the time (in the reference time of the “Sensor Clock”) of zero-crossing R0_{C}, FIG. 7, of the fundamental frequency harmonic, and thereby the zero-time in the signal pattern T0_{T}, i.e., the aforementioned zero-time for the transmitted signal pattern in the “Transmitter Clock” 217 reference time, in the reference time of the “Sensor Clock”. It is noted that as it was previously described, the time T0_{T} in the “Sensor Clock” reference time is located 0.25 T (i.e., π/2 of the full cycle of the fundamental frequency harmonic) before the zero-crossing R0_{C} of the fundamental frequency harmonic, as shown in FIG. 7. The “sensor processor” at this point knows when the aforementioned time T0_{T} corresponds to the reference time of the “Sensor Clock”, and also at what consequent times one period T of the fundamental frequency of the fundamental frequency ω harmonic, i.e., the next T0_{T} would occur on the “Transmitter Clock”, if the signal pattern was continuously transmitted by the polarized RF scanning reference source 226 component and received by the cavity sensor receiver 227 component of the sensory system 230. This means that at this point, the “sensor Clock” is in fact synchronized with the “Transmitter Clock”.

The “sensor processor” will then send a certain number of cycles of the detected signal pattern, FIG. 7, to the “Amplitude Modulation (AM) Transmitter” 228 and thereby by the transmission line 231 to the antenna 229 for transmission of the signal. The transmitted signal pattern may be generated using equation (4) with an arbitrarily selected constant multiplier g(D), e.g., a unity, to adjust the signal amplitude as needed for the “Amplitude Modulation (AM) Transmitter” 228. Alternatively, the received signal, FIG. 7, may be used to generate several cycles of the signal for transmission back to the polarized RF scanning reference source 226 component of the sensory system 230. It is noted that the time in the signal to be transmitted, for example, as generated by equation (4), corresponds to the time in the “Sensor Clock”. The transmitted cycles of the signal pattern must, however, be transmitted by the “Amplitude Modulation (AM) Transmitter” such that the zero-time, i.e., t=0 in equation (4), in the “Sensor Clock” 220 corresponds to the time T0_{T} in the “Transmitter Clock” 217, as it was identified by the “Sensor Processor” 221 while analyzing the detected signal pattern that was transmitted by the polarized RF scanning reference source 226 component of the sensory system 230.

The transmitted signal is then detected by the antenna 223 of the polarized RF scanning reference source 226 component of the sensory system 230 and transmitted to the “Amplitude Modulation (AM) Receiver” 224 by the transmission line 225, where it is generally amplified and digitized and sent to the “Transmitter Processor” 218 for analysis.

The “Transmitter Processor” 218 would then similarly use a well-known Fourier integration algorithm to extract the fundamental frequency and its harmonics constituting the detected signal pattern, for example the fundamental frequency and its first two harmonics for the transmitted pattern described by equations (2) and (3), FIG. 7, in the “Transmitter Clock” 217 time reference, which was referred to as the “transmitter time”.

Then similar to the process followed by the “Sensor Processor” described previously, the “Transmitter Processor” would then identify the time (in the reference time of the “Transmitter Clock” 217) at which the first and second harmonics of the fundamental frequency ω harmonic, i.e., the harmonics with frequencies 2ω and 3ω are in phase (similar to Z1 in FIG. 7, at 0.25 T), the time (in the reference time of the “Transmitter Clock”) of zero-crossing (similar to R0_{C} in FIG. 7) of the fundamental frequency harmonic, and thereby the zero-time T0_{R}, i.e., the zero-time in the signal pattern transmitted by the cavity sensor receiver 227 component and in the “Sensor Clock”, in the “Transmitter Clock” time.

It is appreciated by those skilled in the art that since the aforementioned zero-time T0_{T} of the signal pattern in the “Transmitter Clock” time reference that is transmitted from the polarized RF scanning reference source 226 component of the sensory system 230 is known to the “Transmitter Processor” 218, and since the same signal pattern was transmitted back to the polarized RF scanning reference source 226 component by the cavity sensor receiver 227 component with same zero-time T0_{T} of the signal pattern, therefore the difference between the “Transmitter Clock” zero-time T0_{T} of the signal pattern and the zero-time T0_{R} of the signal pattern that was received by the polarized RF scanning reference source 226 component is due to the time that it takes for the transmitted signal to travel the distance D between the cavity sensor receiver 227 and the polarized RF scanning reference source 226 component of the sensory system 230. Thus, since electromagnetic waves travel at the speed of light c, the distance D is then determined be

$$D = c ( T {0}_{R} - T {0}_{T} ) \qquad ( 8 )$$

where c=299,792,458 m/sec. The “Transmitter Processor” 218 can therefore calculate the distance between the polarized RF scanning reference source 226 component (platform) to the object on which a cavity sensor receiver 227 component is mounted.

It is appreciated by those skilled in the art that the processors, transmission lines, etc. used in the sensory system embodiment 230 may provide time delays in their indicated operations. Such time delays depend on the components used in their construction and the algorithms used in their processing operations. The use of high-speed processors and fast-response electronics and other components in many cases, particularly for measurement of distances that may be tens or hundreds of miles and the required distance measurement precision may make the delays negligible. In all other cases, since the amount of delay can be predicted from component specifications and testing and measured with high precision by testing (calibrating) the sensory system at known distances between its polarized RF scanning reference source 226 component and its cavity sensor receiver 227 component.

It is appreciated that following the above distance calculation process of the “Transmitted Processor” 218, the “Transmitted Processor” knows the zero-time T0_{R}, i.e., the zero-time in the signal pattern transmitted by the cavity sensor receiver 227 component in the “Sensor Clock” reference time, in the “Transmitter Clock” time. This information can then be used by the sensory system 230 to provide the measured distance between the polarized RF scanning reference source 226 component and its cavity sensor receiver 227 component to the

“Sensor Processor” 220 of the cavity sensor receiver, i.e., to the object on which the cavity sensor receiver 227 component of the sensory is mounted. This is accomplished as follows.

The “Transmitter Processor” will then send a certain number of cycles of scanning patterns, equations (2) and (3), that is generated for the orthogonal synchronized polarized electric field signals Eₓ(t) and E_{y}(t), respectively, by the “Transmitter Processor” 218. In this signal pattern, the aforementioned zero-time (t=0) of the pattern as described by the equations (2) and (3), i.e., in “Transmitter Clock” 217 is set as the aforementioned zero-time T0_{R} of the pattern transmitted from the cavity sensor receiver 227, which was extracted by the “Transmitter Processor” as was previously described. The generated orthogonal synchronized polarized electric field signals Eₓ(t) and E_{y}(t) are then transmitted to the pair of antennas 211, which are oriented to properly transmit the orthogonal synchronized polarized signals in the planes of XZ and YZ, FIG. 4, via transmission lines 210.

The two synchronized polarized electric field signals Eₓ(t) and E_{y}(t) are then detected by the cavity sensor (antenna) 212 of the cavity sensor receiver 227 component of the sensory system 230, FIG. 9. The detected signal is then transmitted to the “Dual Channel Amplitude Modulation (AM) Receiver” 222 via the transmission line 213, where it is generally amplified and digitized and sent to the “sensor Processor” 221.

Then as it was described for the initially detected signal pattern, the “Sensor Processor” 221 would then use a well-known Fourier integration algorithm to extract the fundamental frequency and its harmonics constituting the detected signal pattern, for the above signal pattern the fundamental frequency and its first two harmonics for the transmitted pattern as shown in FIG. 7, in the “Sensor Clock” time reference, i.e., in the “sensor time”.

The “sensor processor” would then identify the time (in the reference time of the “Sensor Clock”) at which the first and second harmonics of the fundamental frequency ω harmonic, i.e., the harmonics with frequencies 2 and 3 are in phase (Z1 in FIG. 7, at 0.25 T), the time (in the reference time of the “Sensor Clock”) of zero-crossing (R0_{C} in FIG. 7) of the fundamental frequency harmonic, and thereby the zero-time (T0_{T} in FIG. 7) of the transmitted signal pattern in the “Transmitter Clock” 217 reference time, but now in the reference time of the “Sensor Clock”, hereinafter indicated as the T02_{R}.

It is appreciated by those skilled in the art that since the aforementioned zero-time T0_{T} of the signal pattern in the “Transmitter Clock” time reference that was initially transmitted from the polarized RF scanning reference source 226 component of the sensory system 230 is known to the “Sensor Processor” 221, and since the same signal pattern was transmitted from the polarized RF scanning reference source 226 component to the cavity sensor receiver 227 component with zero-time T0_{R} of the signal pattern, therefore the difference between the zero-time T0_{R2} and the “Transmitter Clock” zero-time T0_{T} and the zero-time T0_{R2} of the signal pattern that was received by the cavity sensor receiver 227 component is due to the time that it takes for the transmitted signal to travel the distance D between the cavity sensor receiver 227 component and the polarized RF scanning reference source 226 component of the sensory system 230. Thus, since electromagnetic waves travel at the speed of light c, the distance D is then determined be

$$D = c ( T {0}_{R 2} - T {0}_{T} ) \qquad ( 9 )$$

where c=299,792,458 m/sec. The cavity sensor receiver 227 component can therefore calculate the distance between itself and the polarized RF scanning reference source 226 component (platform) of the sensory system.

It is appreciated by those skilled in the art that the reason for the use of the polarized RF scanning reference sources (200) and cavity sensors (202), FIG. 4, for transmitting the indicated scanning patterns (equations (2) and (3) or (5) and (6) or other previously described signal patterns) is for the purpose of enabling the object (204) that is provided with the cavity sensor (202) to measure its roll angle (about the line of wave propagation, i.e., the Z axis of the reference source XYZ, FIG. 4) relative to the polarized RF scanning reference sources (200). The sensory systems 215 and 230 of FIGS. 8 and 9, respectively, were shown to be designed with the capability of making distance measurements between their polarized RF reference source platforms (214 and 226 in FIGS. 8 and 9, respectively) and the cavity sensor receiver components (216 and 227 in FIGS. 8 and 9, respectively). It is, however, appreciated that the same sensory systems 215 and 230 of FIGS. 8 and 9, respectively, may be used for the sole purpose of making the described distance measurements.

It is appreciated by those skilled in the art that if the purpose of the sensory system is to only measure distance between two platforms, then the sensory system 230 may be used for this purpose and the angle measurement capability of the sensory system becomes an extra orientation measurement, which is needed for performing the distance measurement, but does not need to be calculated or used.

It is also appreciated by those skilled in the art that by providing at least two polarized RF reference source platforms 226, FIG. 9, with non-parallel wave propagation directions and known distances apart, a two-dimensional map, e.g., a geo-location map, of the location of the objects to which cavity sensor receiver 227 components are attached in a coordinate system defined by the polarized RF reference source platforms can then be generated using well-known triangulation techniques. It is appreciated that the minimum number of polarized RF reference source platforms 226, FIG. 9, needed is two for such geo-location mapping over a relatively flat ground. However, the provision of more polarized RF reference source platforms would increase the accuracy of the generated geo-location maps.

If the objects to which cavity sensor receiver 227 components are attached are not located on a relatively flat surface, then a three-dimensional “geo-location” map needs to be generated using at least three polarized RF reference source platforms 226, FIG. 9, with non-parallel wave propagation directions and non-parallel common normal to the directions of wave propagation. The three-dimensional map of the location of the objects to which cavity sensor receiver 227 components are attached in a coordinate system defined by the polarized RF reference source platforms can then be generated using well-known triangulation techniques. It is appreciated that the minimum number of polarized RF reference source platforms 226, FIG. 9, needed is three for such three-dimensional geo-location mapping of the objects to which the cavity sensor receiver 227 components are attached. However, the provision of more polarized RF reference source platforms would increase the accuracy of the generated geo-location maps.

In the example of the scanning vector field Ē(t)=Eₓ(t)\hat{ι}+E_{y}(t)Ĵ formed by the orthogonal synchronized polarized electric field signals Eₓ(t) and E_{y}(t) shown in FIGS. 4 and 5 were modulated as described in equations (2) and (3), with the resulting electric field detected by the cavity sensor 202 will then becoming as described by equation (4). It is, however, appreciated that as it was described from the plots of FIG. 7, the “Transmitter Clock” zero-time T0_{T} is determined from the time Z1, when the first and second harmonics of the fundamental frequency ω (i.e., harmonics with frequencies 2ω and 3ω) of the received signal are in phase, regardless of their amplitudes. This means that the amplitudes of these two harmonic components in the orthogonal synchronized polarized electric field signals Eₓ(t) and E_{y}(t), equations (2) and (3), respectively, do not have to be equal, i.e., be a. Thus, the orthogonal synchronized polarized electric field signals Eₓ(t) and E_{y}(t) may be described as

$${E}_{x} ( t ) = a cos ω t + b cos 2 ω t + d \qquad ( 10 )$$

$${E}_{y} ( t ) = a sin ω t + c sin 3 ω t + d \qquad ( 11 )$$

where ω is the fundamental frequency of both signals, a and b are constant signal amplitudes and dis the constant that provides a proper amplitude modulation index.

The electric field detected by the cavity sensor 202, FIG. 4, will then becomes

$$\begin{matrix}R ( t ) = g ( D ) ( {E}_{x} ( t ) cos θ + {E}_{y} ( t ) sin θ ) \\ = g ( D ) \{ ( a cos ω t + b cos 2 ω t + d ) cos θ + \\ ( a sin ω t + c sin 3 ω t + d ) sin θ \} \\ = g ( D ) [ a ( cos ω t cos θ + sin ω t sin θ ) + b cos θcos 2 ω t + \\ c sin θsin3ω t + d ( sin θ + cos θ ) ] \\ = g ( D ) [ a cos ( ω t - θ ) + b cos θcos2ω t + c sin θsin3ω t + \\ d ( sin θ + cos θ ) ]\end{matrix} \qquad ( 12 )$$

It is readily seen from equation (12) that as was described for equation (4), the roll angle θ can be determined from the phase shifting of the fundamental frequency ω and the zero crossing of the fundamental frequency that occurs when the harmonics 2ω and 3ω are in phase as shown in the example below, FIG. 7. This can be done since as can be seen in equation (12), when ωt=π/2, cos 2ωt=−1 and sin 3ωt=−1, i.e., the harmonics 2ω and 3ω are in phase. The time corresponding to ωt=π/2 would obviously correspond to quarter of the period T of the fundamental frequency ω, i.e., π/4.

It is, therefore appreciated by those skilled in the art that the magnitude of the coefficients b and c in the orthogonal synchronized polarized electric field signals Eₓ(t) and E_{y}(t) equations (10) and (11), respectively, may be arbitrarily selected. The magnitude of the coefficients b and c may then be used to transmit data from the polarized RF reference source platforms (e.g., 214 and 226 of FIGS. 8 and 9, respectively) to the objects to which cavity sensor receiver components (e.g., 216 and 227 of FIGS. 8 and 9, respectively) are attached.

It is also appreciated by those skilled in the art that since the amplitudes of the signal, equation (12), by the cavity sensor receiver components (e.g., 216 and 227 of FIGS. 8 and 9, respectively) of the object to which it is attached is dependent on the distance to the transmitter platform as indicated by the function g(D), therefore the ratio of the detected magnitude of the coefficients b and c, equation (12), considering the since and cosine of the measured angle θ, may be used for data transmission. The use of such ratio values for data transmission, e.g., by assigning numbers and alphabets to ranges of such ratio values, is well known in the art and may be used for this purpose.

It is also appreciated by those skilled in the art that by increasing the number of fundamental frequency harmonics in the transmitted orthogonal synchronized polarized electric field signals Eₓ(t) and E_{y}(t), for example by using the added harmonics used in equations (5) and (6) as described in equations (13) and (14) below

$${E}_{x} ( t ) = a cos ω t + b cos 2 ω t + c cos 4 ω t + d \qquad ( 10 )$$

$${E}_{y} ( t ) = a sin ω t + e sin 3 ω t + f sin 5 ω t + d \qquad ( 11 )$$

Then four harmonic amplitudes and their ratios become available for embedding data in the transmitted signal patterns. As a result, more (twice as much) information can be embedded in each transmitted signal pattern.

A method was previously described that can be used by the sensory system embodiment 230 of FIG. 9 to determine the distance between the polarized RF scanning reference source component 226 of the sensory system and the cavity sensor receiver component 227 (which is attached to the object of interest, such as a munition or a UAV or a UGV) of the sensory system. The distance was shown to be based on measuring the time of travel of a specifically designed transmitted orthogonal synchronized polarized electric field signals, for example those described by the polarized electric fields by equations (2) and (3) between the above two components of the sensory system.

The above-described method may then be extended to provide the sensory system embodiment 230 of FIG. 9 with the capability of transmitting guidance signals to the object that is provided with the cavity sensor receiver component 227, i.e., the next desired positioning of the object with or without time duration for the move. It is appreciated that the desired move may be along the measured distance or may be a two-or three-dimensional move. It is appreciated that for two-or three-dimensional moves, two and three polarized RF scanning reference source component 226 are going to be required, respectively, each of which provides the desired move to be made, i.e., the desired change in the distance between each polarized RF scanning reference source component 226 and the object that is provided with the cavity sensor receiver component 227. The method for providing each polarized RF scanning reference source component 226 with the capability to transmit the desired move to the object, i.e., the desired change in the distance between the polarized RF scanning reference source and the object, is described as follows.

In this method, the previously described method is used by the sensory system embodiment 230 of FIG. 9 to measure the distance between its polarized RF scanning reference source component 226, hereinafter referred to as the “reference source platform”, and the object that is provided with the cavity sensor receiver component 227, hereinafter referred to as the “moving object”. It is also noted that in the process of determining the distance between the “reference source platform” and the “moving object”, the transmitter clock 217 and the sensor clock 220 are also synchronized as was previously described. The distance between the “reference source platform” and the “moving object” was also determined based on the time of transmitted signal pattern between them, equation (9).

Now, once the transmitter clock 217 and the sensor clock 220 are synchronized, then the “reference source platform” can transmit new scanning patterns (equations (2) and (3) or (5) and (6) or other previously described signal patterns), with an adjusted “Transmitter Clock” 217 “zero time” of the polarized RF scanning reference source 226 component of the sensory system 230. The amount of “zero time” adjustment would correspond to the amount of change that the “moving object” needs to make to its distance from the “reference source platform”. It is appreciated that by pulling the “zero time” certain amount back, the time of travel that is calculated at the cavity sensor receiver component 227 of the “moving object” is increased, thereby indicating that the “moving object” has to increase its distance to the “reference source platform”. Obviously pushing the “zero time” certain amount forward, the time of travel that is calculated at the cavity sensor receiver component 227 of the “moving object” is reduced, thereby indicating that the “moving object” has to decrease its distance to the “reference source platform”.

It is appreciated by those skilled in the art that when two-or three-dimensional moves of the “moving object” is desired, then two and three polarized RF scanning reference source component 226 are going to be required, respectively, for each of which the desired move that has to be made is transmitted to the “moving object” as is described above. The sensory system embodiment 230 of FIG. 9 would thereby provide the “moving object” with the capability of being guided to is intended target position with the guidance information being provided by the “reference source platforms”. It is also appreciated by those skilled in the art that the target position and the “moving object” position at any point in time is indicated in a referencing coordinate system defined by the “reference source platforms” as was previously described.

It is also appreciated by those skilled in the art that if more than the minimum number of “reference source platforms” are provided, for example more than three “reference source platforms” for three-dimensional “moving object” position measurement and desired movement commands towards the intended target positioning, then both position measurements and the required movement measurements become more precise.

As a result, with the described method, this sensory system embodiment 230 of FIG. 9 can be used for guiding the “moving object” towards a static or dynamic target.

It is also appreciated by those skilled in the art that in practice, to avoid distance (wave travel time) measurement error accumulation, it is highly desirable to regularly update the synchronization of the “Transmitter Clock” 217 “zero time” of the polarized RF scanning reference source 226 component (“reference source platform”) and the “Sensor Clock” of the cavity sensor receiver component 227 (“moving object”). The regular “Transmitter Clock” and “Sensor Clock” synchronization transmitted scanning signal patterns may be readily differentiated from guidance distance command signals using different methods, such as by the use of previously described embedded data, i.e., through the use of the amplitude ratios of the 2ω and 3ω in the scanning signal patterns of equations (2) and (3).

It is also appreciated by those skilled in the art that sensory system embodiment 230 of FIG. 9 can measure distance to multiple fixed and “moving objects” and provide the above guidance, i.e., desired distance change for target intercept for one-two-and three-dimensional movements. This is readily accomplished by assigning identifying codes to each “moving object” and transmitting the scanning signal patterns with the identifying code, for example, by using the use of previously described embedded data, i.e., through the use of the amplitude ratios of the 2ω and 3ω in the scanning signal patterns of equations (2) and (3) or the harmonics of equations (10) and (11).

It is appreciated that as it is well known in the art, if the “moving objects” are traveling at extremely high speeds, for example 10 to 15 times speed of sound, the speed of travel can be readily determined by measuring the change (the amount of decrease) in the fundamental frequency and the harmonics of the transmitted scanning pattern signal from the “reference source platform”, noting that the resulting increase in the period of the transmitted signal pattern is due to the velocity of the “moving objects”. It is appreciated that in most applications, the resulting error in distance calculations, even at above extremely high speeds, is negligible. However, the error is readily corrected by measuring the speed of the “moving object” and accounting for it, i.e., by accounting for the distance traveled during the wave travel time from the “reference source platform” to the “moving object”.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. (canceled)

2. A polarized radio frequency (RF) position measurement system, comprising:
a polarized RF scanning reference source comprising:
a first processor configured to generate a scanning pattern waveform comprised of orthogonal synchronized polarized first and second signals that have differently modulated field amplitudes; and
a dual channel RF transmitter configured to receive the scanning pattern waveform from the first processor and to transmit an electromagnetic wave comprised of the first and second signals; and
a cavity sensor receiver comprising:
a cavity sensor, the cavity sensor being configured and oriented to detect the transmitted electromagnetic wave and being configured to provide a detected signal in response thereto; and
a second processor configured to receive the detected signal and configured to extract a fundamental frequency and two or more harmonic frequencies from the detected signal and therefrom, configured to determine an orientation of the cavity sensor receiver with reference to the polarized RF scanning reference source.

3. The system of claim 2, wherein the second processor is configured to determine a timing reference from the detected signal, wherein the processor is further configured to utilize the timing reference to extract the fundamental frequency and the two or more harmonic frequencies.

4. The system of claim 3, wherein the second processor is configured to identify a first time in the timing reference at which first and second harmonics of the fundamental frequency are in phase.

5. The system of claim 4, wherein the second processor is configured to determine a zero crossing time of the fundamental frequency using the timing reference.

6. The system of claim 5, wherein the second processor is configured to determine the orientation of the cavity sensor receiver as a corresponding angle between the zero crossing time and the first time of the detected signal.

7. The system of claim 2, wherein the determined orientation is a roll angle of the cavity sensor receiver with reference to the polarized RF scanning reference source.

8. The system of claim 2, wherein the RF transmitter is configured to include third and fourth harmonics as a part of the electromagnetic wave and wherein the second processor is configured to extract the third and fourth harmonic frequencies from the detected electromagnetic wave and therefrom, configured to determine the orientation of the cavity sensor receiver with reference to the polarized RF scanning reference source based on the fundamental frequency and at least four harmonic frequencies.

9. The system of claim 2, wherein the cavity sensor is two or more cavity sensors, where at least a first one of the two or more cavity sensors is configured with increased sensitivity to roll angle and decreased sensitivity to pitch and yaw.

10. The system of claim 2, wherein the cavity sensor is three or more cavity sensors, where at least a first one of the three or more cavity sensors are configured with increased sensitivity to roll angle and decreased sensitivity to pitch and yaw, wherein at least a second one of the three or more cavity sensors are configured with increased sensitivity to pitch and decreased sensitivity to roll angle and yaw and wherein at least a third one of the three or more cavity sensors are configured with increased sensitivity to yaw and decreased sensitivity to pitch and roll angle, and wherein the second processor is configured to determine a three-dimensional orientation of the cavity sensor receiver with reference to the polarized RF scanning reference source.

11. The system of claim 2, wherein the electromagnetic wave is a first electromagnetic wave, wherein the polarized RF scanning reference source comprises an RF receiver and a clock reference, wherein the clock reference is utilized by the first processor to generate the scanning pattern waveform, wherein the cavity sensor receiver comprises an RF transmitter, wherein the second processor is configured to determine a timing reference from the detected signal and is coupled to the RF transmitter to transmit a second electromagnetic wave using the determined timing reference, wherein the RF receiver is configured to detect the second electromagnetic wave and is configured to provide a corresponding signal to the first processor, wherein the first processor is configured to determine a timing of the second electromagnetic wave and compare the timing to the clock reference to determine a distance between the polarized RF scanning reference source and the cavity sensor receiver.

12. A cavity sensor receiver comprising:
a cavity sensor, the cavity sensor being configured and oriented to detect a transmitted electromagnetic wave comprising a scanning pattern waveform comprised of orthogonal synchronized polarized first and second signals that have differently modulated field amplitudes, the cavity sensor being further configured to provide a detected signal in response thereto; and
a processor configured to receive the detected signal and configured to extract a fundamental frequency and two or more harmonic frequencies from the detected signal and therefrom, configured to determine an orientation of the cavity sensor receiver with reference to a polarized RF scanning reference source that transmitted the electromagnetic wave.

13. The receiver of claim 12, wherein the processor is configured to determine a timing reference from the detected signal, wherein the processor is further configured to utilize the timing reference to extract the fundamental frequency and the two or more harmonic frequencies.

14. The receiver of claim 13, wherein the processor is configured to identify a first time in the timing reference at which first and second harmonics of the fundamental frequency are in phase.

15. The receiver of claim 14, wherein the processor is configured to determine a zero crossing time of the fundamental frequency using the timing reference.

16. The receiver of claim 15, wherein the processor is configured to determine the orientation of the cavity sensor receiver as a corresponding angle between the zero crossing time and the first time of the detected signal.

17. The receiver of claim 12, wherein the determined orientation is a roll angle of the cavity sensor receiver with reference to the polarized RF scanning reference source.

18. The receiver of claim 12, wherein the electromagnetic wave is a first electromagnetic wave, wherein the cavity sensor receiver comprises an RF transmitter, wherein the second processor is configured to determine a timing reference from the detected signal and is coupled to the RF transmitter to transmit a second electromagnetic wave using the determined timing reference.

19. A method of generating a signal to measure a position of an object, the method comprising:
receiving a timing reference;
generating a signal comprised of orthogonal polarized first and second electric field signals that have differently modulated field amplitudes that are synchronized to the timing reference; and
providing the signal to measure the position of the object.

20. The method of claim 19, wherein the signal is comprised of first and second signal portions, wherein the generating of the signal comprises:
generating a first signal portion Eₓ(t) as follows:
$${E}_{x} ( t ) = a ( cos ω t + cos 2 ω t ) + b ;$$
generating a second signal portion E_{y}(t) as follows:
$${E}_{y} ( t ) = a ( sin ω t + sin 3 ω t ) + b ,$$
where ω is the fundamental frequency of both signals, a is a constant signal amplitude, b is an amplitude modulation index constant and t is the timing reference.

21. The method of claim 20, wherein the generating the first signal portion Eₓ(t) comprises adding at least one harmonic frequency cos 2nω, and wherein the generating the second signal portion E_{y}(t), comprises adding at least one harmonic frequency sin(2n+1)ω, wherein n is an integer.

22. A polarized radio frequency (RF) angle measurement and time referencing system, comprising:
a polarized RF scanning reference source comprising:
a first processor configured to generate a scanning pattern waveform comprised of orthogonal synchronized polarized first and second signals consisting of periodic time functions; and
a dual channel amplitude modulation transmitter to receive the generated first and second signals from the first processor; and
transmit electromagnetic waves from the first and second planar polarized antennas comprised of the first and second signals; and
a cavity sensor receiver comprising:
a cavity sensor, the cavity sensor being configured and oriented to detect the transmitted electromagnetic waves and being configured to provide a detected signal in response thereto; and
a second processor configured to receive the detected signal and configured to extract the fundamental frequency of the received periodic time function pattern and therefrom, configured to determine a timing reference in the clock of the polarized RF scanning reference source in its clock time and orientation of the cavity sensor receiver with reference to the polarized RF scanning reference source.

23. The system of claim 22, wherein the second processor is configured to determine the fundamental frequency of the received time function pattern and the associated features of the time function pattern.

24. A polarized radio frequency (RF) distance measurement and time referencing system, comprising:
a polarized RF scanning reference source comprising:
a first processor configured to generate a scanning pattern waveform comprised of orthogonal synchronized polarized first and second signals consisting of periodic time functions consisting of a fundamental frequency and at least its first two harmonics; and
a dual channel amplitude modulation transmitter to receive the generated first and second signals from the first processor; and
transmit electromagnetic waves from the first and second planar polarized antennas comprised of the first and second signals; and
an antenna for receiving signals transmitted from the system cavity sensor receiver; and
an amplitude modulation receiver to receiver the signal from the antenna, and
a cavity sensor receiver comprising:
a cavity sensor, the cavity sensor being configured and oriented to detect the transmitted electromagnetic waves and being configured to provide a detected signal in response thereto; and
a second processor configured to receive the detected signal pattern and configured to extract the fundamental frequency of the received periodic time function pattern and therefrom, configured to determine a timing reference in the clock of the polarized RF scanning reference source in its clock time and orientation of the cavity sensor receiver with reference to the polarized RF scanning reference source and generate the received periodic signal pattern as synchronized with the extracted timing reference of the polarized RF scanning reference source in the clock of the cavity sensor receiver, and
an amplitude modulation transmitter to receive the generated signal pattern from the second processor; and
transmit electromagnetic waves from the cavity sensor receiver antenna of the generated periodic signal pattern.
